(19) United States
(12) Patent Application Publication
(10) Pub. No.: US 2024/0144679 A1
(43) Pub. Date: May 2, 2024

(54) Online Surgical Phase Recognition with Cross-Enhancement Causal Transformer

(71) Applicant: Verb Surgical Inc., Santa Clara, CA (US)

(72) Inventor: Bokai Zhang, Santa Clara, CA (US)

(21) Appl. No.: 18/496,741

(22) Filed: Oct. 27, 2023

Related U.S. Application Data
(60) Provisional application No. 63/420,453, filed on Oct. 28, 2022.

(51) Int. Cl. G06V 20/40; G06V 10/82

(52) U.S. Cl. CPC G06V 20/41; G06V 10/82; G06V 20/46; G06V 20/49; G06V 2201/03

(57) ABSTRACT

A Cross-Enhancement Causal Transformer or simply a Cross-Enhancement Transformer (C-ECT) is described as a modification of previous transformer architectures that is suitable for online surgical phase recognition. Additionally, a Cross-Attention Feature Fusion (CAFF) is described that better integrates the global and location information in the C-ECT. This can achieve better performance on the Cholec80 dataset than the current state-of-the-art methods in accuracy and precision, recall, and in the Jaccard score. Other aspects are also described and claimed.

### CROSS-REFERENCE TO RELATED APPLICATION

This nonprovisional patent application claims the benefit of the earlier filing date of U.S. Provisional Application No. 63/420,453 filed 28 Oct. 2022.

### FIELD

An aspect of the disclosure here relates to machine-learning model based processing of digital images to detect or recognize various phases of a surgical procedure captured in the digital images.

### BACKGROUND

Automatic online recognition of surgical phases can provide insight that can help surgical teams make better decisions that leads to better surgical outcomes. Current state-of-the-art artificial intelligence, AI, approaches for surgical phase recognition utilize both spatial and temporal information to learn context awareness in surgical videos.

### SUMMARY

One aspect of the disclosure here is a system having one or more processors and a memory storing instructions to be executed by the one or more processors to: extract a sequence of extracted feature sets from a surgical video frame by frame; analyze the sequence of extracted feature sets to recognize one or more surgical actions; and segment the surgical video into a plurality of video segments, each video segment corresponding to a recognized surgical action. The processor may extract the sequence using a machine learning model referred to as a feature extraction network. The feature extraction network may be a family of image classification neural networks. The processor analyzes and segments using a machine learning model referred to as an action segmentation network.

Another aspect is a method for surgical phase recognition, comprising the following operations performed by a programmed processor: extracting a sequence of extracted feature sets from a surgical video frame by frame; analyzing the sequence of extracted feature sets to recognize one or more surgical actions; and segmenting the surgical video into a plurality of video segments, each video segment corresponding to a recognized surgical action. The sequence of extracted feature sets from the surgical video may be performed by a feature extraction network which may be a member of a family of image classification neural networks.

Yet another aspect is an article of manufacture comprising a machine readable medium having stored therein instructions that configure a computer to perform surgical action recognition by: extracting a sequence of extracted feature sets from a surgical video frame by frame; analyzing the sequence of extracted feature sets to recognize one or more surgical actions; and segmenting the surgical video into a plurality of video segments, each video segment corresponding to a recognized surgical action.

A Cross-Enhancement Causal Transformer or simply a Cross-Enhancement Transformer (C-ECT) is described as a modification of previous transformer architectures that is suitable for online surgical phase recognition. Additionally, a Cross-Attention Feature Fusion (CAFF) is described that better integrates the global and location information in the C-ECT. This can achieve better performance on the Cholec80 dataset than the current state-of-the-art methods in accuracy and precision, recall, and in the Jaccard score.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several aspects of the disclosure here are illustrated by way of example and not by way of limitation in the figures of the accompanying drawings. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 is a block diagram of a computerized method for surgical phase recognition.

FIG. 2 depicts an example of the encoder series and the decoder series in a modified ASFormer.

FIG. 3a is a block diagram of an example Cross-Enhancement Transformer.

FIG. 3b is a block diagram of another example Cross-Enhancement Transformer.

FIG. 4 is a visual representation of the online surgical phase recognition results for a) EffNetV2 MS-TCN and b) EffNetV2 C-ECT with CAFF.

### DETAILED DESCRIPTION

Several aspects of the disclosure with reference to the appended drawings are now explained. Whenever the shapes, relative positions and other aspects of the parts described are not explicitly defined, the scope of the invention is not limited only to the parts shown, which are meant merely for the purpose of illustration. Also, while numerous details are set forth, it is understood that some aspects of the disclosure may be practiced without these details. In other instances, well-known circuits, structures, and programming techniques have not been shown in detail so as not to obscure the understanding of this description.

Online recognition of surgical phase in the modern operating room can provide intelligent context-aware information that can reduce inter-operative cognitive loads on surgeons and can provide valuable insight and feedback to the surgical team to improve operating skills and efficiency. AI-driven approaches for surgical phase recognition have shown considerable progress in recent years. While initial approaches looked at surgical phase recognition as a classification problem at the frame level, current techniques leverage both spatial and temporal information to build contextual understanding in surgical videos. More recently, transformer-based architectures have been proposed to refine the temporal context even further leading to current state-of-the-art results.

An aspect of the disclosure here is a computerized method for surgical phase recognition expands upon transformer-based approaches for online surgical phase recognition, as a Causal Transformer for Action Segmentation (Causal ASFormer) for online surgical phase recognition. The Causal ASFormer can be implemented by modifying an ASFormer; the ASFormer is described in yi2021asformer, YI, F., et al., “ASFormer: Transformer for Action Segmentation”, arXiv:2110.08568 [cs.CV], Oct. 16, 2021.

In another aspect, a Cross-Enhancement Causal Transformer (C-ECT) is disclosed for online surgical phase recognition. The C-ECT can be implemented by modifying an ASFormer and a CETNet which is described in wang2022cross, Jiahui Wang, Zhenyou Wang, Shanna Zhuang, and Hui Wang, “Cross-enhancement transformer for action segmentation,” arXiv preprint arXiv:2205.09445, 2022.

Another aspect is a Cross-Attention Feature Fusion (CAFF) which integrates global and local information in the network inspired by the design of the Feature Pyramid Network (FPN). The FPN is described in lin2017feature, Tsung-Yi Lin, Piotr Doll'ar, Ross Girshick, Kaiming He, Bharath Hariharan, and Serge Belongie, “Feature pyramid networks for object detection,” in CVPR, 2017, pp. 2117-2125.

The Cholec80 dataset was used to develop the method. The Cholec80 dataset is composed of 80 cholecystectomy surgery videos performed by 13 surgeons. The dataset includes annotations for both the surgical phase and tool presence. The 7 surgical phases include “Preparation”, “Calot triangle dissection”, “Clipping and cutting”, “Gallbladder dissection”, “Gallbladder packaging”, “Cleaning and coagulation”, and “Gallbladder retraction”. The first 40 videos were used for training, and the remaining 40 were used for testing following previous research.

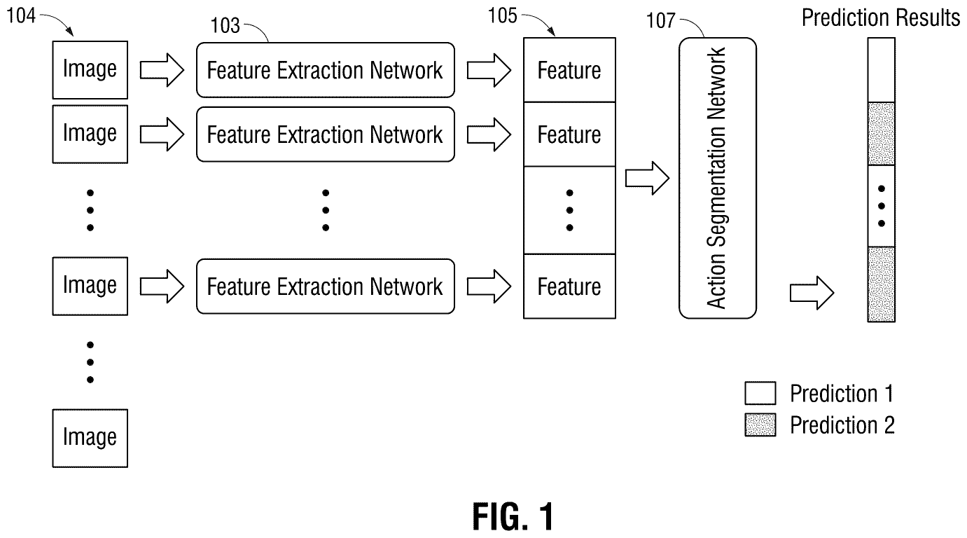

An overall block diagram of the method is illustrated in FIG. 1. First, a feature extraction network 103 is trained with video frames (images 104) extracted from the dataset and their surgical phase annotations. Second, frame features 105 are extracted for each video frame using the trained version of the feature extraction network 103. Third, the extracted frame features 105 are concatenated to obtain a set of full video features as the training data for an action segmentation network 107. Finally, the action segmentation network 107 is trained with the set of full video features to achieve surgical phase recognition.

For the feature extraction network 103, EfficientNetV2 as described in tan2021efficientnetv2, TAN, M., et al., “EfficientNetV2: Smaller Models and Faster Training”, Proceedings of Machine Learning Research, Vol. 139, Jun. 23, 2021, may be used. EfficientNetV2 refers to a family of new image classification models that systematically studies models' architecture optimization. A contribution of this new model is the use of a “training-aware neural architecture search” algorithm that refines the model architecture while concurrently making the training faster and the model's inference latency shorter. In order to robustly evaluate the model's performance during an architecture search independently from a model parameters search, a subset of data, called ‘minival’, is defined and employed. Importantly, EfficientNetV2 proposes an intuitive and effective solution to avoid over-fitting to large-size high-resolution images, called “progressive training”, by adaptively adjusting the regularization level.

### Action Segmentation Network

In one aspect of the online surgical phase recognition method described here, for each time step, the feature extraction network 103 will extract the features and save them. At time step t, features before and at time step t will be utilized to build feature set F={f_1, f_2, . . . , f_t}. The action segmentation network 107 is based on a transformer model, and utilizes feature set F to produce prediction output P=(P_1, P_2, . . . , Pt), where P_t is referred to here as an online prediction result at the time step t. Instead of utilizing MS-TCN which is described in farha2019 ms, Yazan Abu Farha and Jurgen Gall, “Ms-tcn: Multi-stage temporal convolutional network for action segmentation,” in CVPR, 2019, pp. 3575-3584, as the action segmentation network 107 to achieve surgical phase recognition, networks that utilize transformers such as ASFormer are now modified, to achieve surgical phase recognition.

### Causal Transformer for Action Segmentation

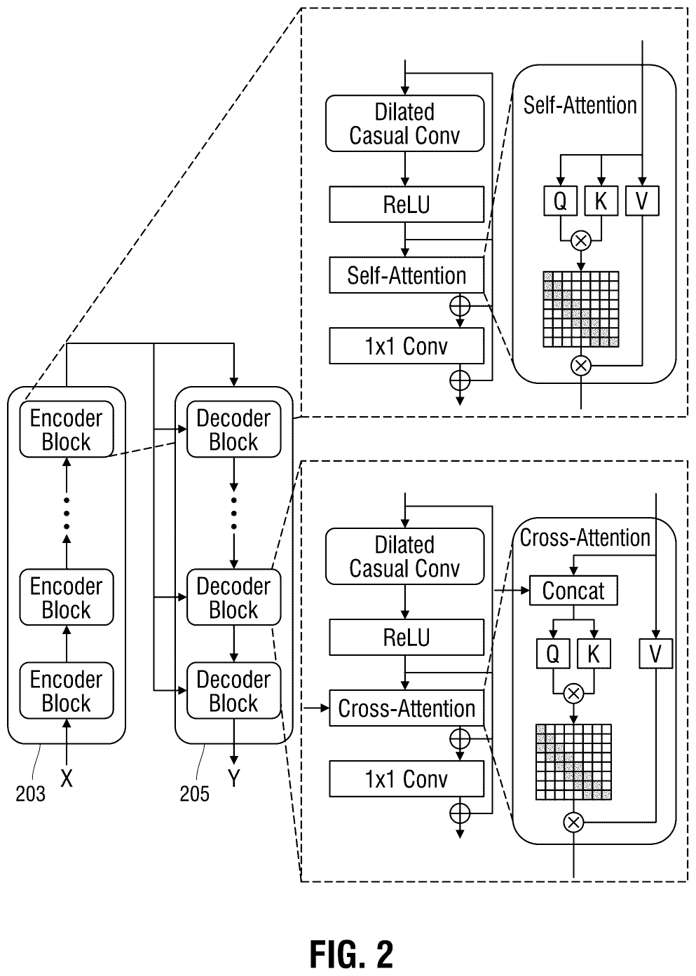

The transformer for the action segmentation network 107, e.g., a modified ASFormer, may be created by following an encoder-decoder architecture. As shown in the example of FIG. 2, the encoder of the modified ASFormer contains an encoder series 203 of one or more encoder blocks, while the decoder series 205 of the modified ASFormer contains a series of one or more decoder blocks. To achieve online surgical phase recognition, each encoder block and each decoder block is modified to ensure the causality of the network. As shown in the inset view of one of the encoder blocks in FIG. 2, each encoder block utilizes dilated causal convolution and a self-attention layer with residual connections, e.g., each of the one or more encoder blocks includes a dilated causal convolution and a self-attention layer based on a causal local attention with residual connections. The self-attention layer utilizes causal local attention (sliding window attention/band attention) which constrains its receptive field within a local window. The local window size is doubled in each block. FIG. 2 also has an inset view of one of the decoder blocks. Each decoder block contains dilated causal convolution and a cross-attention layer that utilizes or is based on causal local attention. In the cross-attention layer, the query Q and key K are obtained using the output from the encoder series 203 and the output from the previous layer. Unlike Q and K, value V is obtained from the output of the previous layer.

### Cross-Enhancement Causal Transformer for Action Segmentation

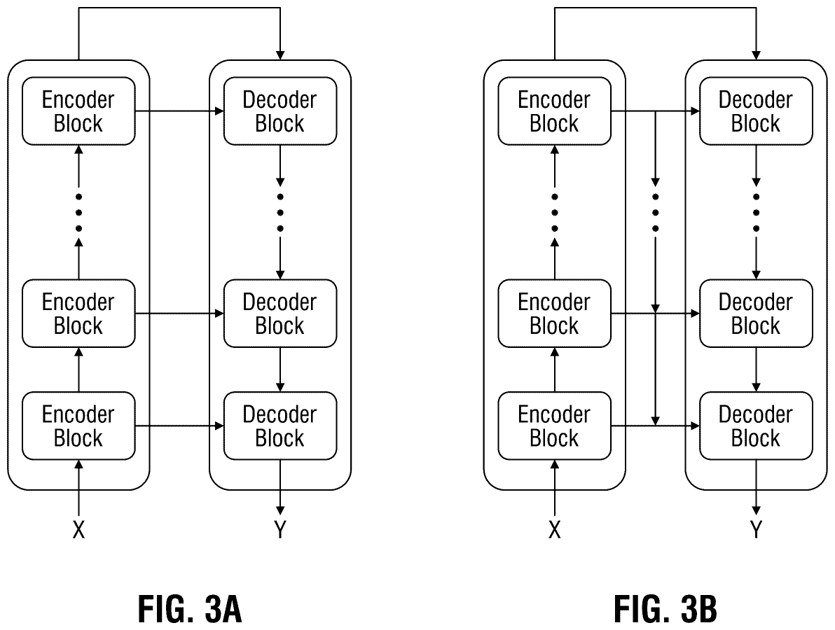

To incorporate features learned in the lower layer of the networks which contains local information, a Cross-Enhancement Causal Transformer (C-ECT) can be implemented by modifying the cross-attention in the ASFormer. In the C-ECT, the value V in the cross-attention layer in each decoder block is obtained from the self-attention of the corresponding layer in the encoder series 203 as shown in FIG. 3a. In this way, the decoder series 205 is aligned with the self-attention layer of the encoder series 203 to continuously learn both global and local information. Similar to how the ASFormer is modified here for online prediction, the Cross-Enhancement Causal Transformer (C-ECT) may be built for online surgical phase recognition.

Inspired by the Feature Pyramid Network (FPN), in another aspect of the disclosure here, the features generated in the encoder blocks of the encoder series 203 are fused for the cross-attention layers in the decoder series 205 to further integrate the global and local information in the network as shown in FIG. 3b. Value V in the cross-attention layer in each decoder block is obtained from the fusion of the features generated by the encoder blocks. These features can be calculated in a bottom-up path by

F_{i−1}=w_{1,i}×F_{i−1}+w_(2,i)×F_(i)
where F_(i) represents the feature generated in the ith encoder block. The w_{1,i} and w_{2,i} are weighted parameters that are learned during training. This is referred to as a feature generation process Cross-Attention Feature Fusion, CAFF.

To assess model performance, measurements commonly used in surgical phase recognition may be employed such as accuracy, precision, recall, and Jaccard scores. The precision, recall, and Jaccard scores may be computed for each surgical phase and then averaged over all surgical phases. However, these frame-level metrics are not convenient to assess over segmentation errors. In order to evaluate predictions and over-segmentation errors, segmental metrics may be used, for example the segmental distance score, and the segmental F1 score at selected overlapping thresholds (0.1, 0.25, and 0.50). For comparison purposes, the average of the segmental F1 score at overlapping thresholds may be computed by

F1@AVG=⅓×(F1 @10+F1 @25+F1@50)

The feature extraction network 103 (see FIG. 1) may be implemented as EfficientNetV2 (EffNetV2), trained with the Cholec80 dataset. The SGD optimizer may be used with a learning rate of 1e⁻⁴. The weight decay may be set to 1e⁻⁵. The bar size may be set to 16 and the training epochs to 50. The dropout rate may be set to 0.4. Other combinations for such training parameters are possible. For data augmentation purposes, the smaller side of the frames may be resized to 400 pixels and randomly cropped into 384*384 patches from the resized frames as the training samples. Also, a randomly selected 15% of the training samples may be used for random rotation within 10 degrees.

The MS-TCN and the Causal ASFormer and C-ECT may be trained with cross-entropy loss and smooth loss. The Adam optimizer may be used with a learning rate set to 5e⁻⁴. The batch size may be set to 1 and the training epochs to 200. The dropout rate may be set to 0.5. The total number of stages in MS-TCN may be set to 2. Other training parameters are possible. In one aspect, only one encoder and only one decoder are used for the Causal ASFormer and C-ECT. The total number of dilated causal convolution layers at each stage may be set, for each encode and for each decoder, to 10. The number of features may be mapped to 64.

### Results

Different methods are developed with different combinations of the feature extraction network 103 and the action segmentation network 107. In particular, EffNetV2 causal MS-TCN, EffNetV2 Causal ASFormer, EffNetV2 C-ECT, and EffNetV2 C-ECT with CAFF were tested on the Cholec80 dataset. These methods outperform current state-of-the-art methods, in terms of accuracy and precision, recall, and Jaccard score. For instance, EffNetV2 Causal ASFormer outperforms EffNetV2 MS-TCN by approximately 1% in terms of accuracy and Jaccard score and approximately 1.5% in terms of precision. EffNetV2 C-ECT and EffNetV2 Causal ASFormer have similar performance in terms of frame metrics. EffNetV2 C-ECT with CAFF outperforms EffNetV2 C-ECT by approximately 1% in terms of precision, recall, and Jaccard score.

To conduct a further comparison between the methods described here, the overall accuracy and segmental metrics may be calculated including the segmental edit distance score, the segmental F1 score at overlapping thresholds of 10%, 25%, and 50%, and their average. The EffNetV2 Causal ASFormer outperforms EffNetV2 MS-TCN by approximately 20% in terms of segmental F1 scores at different thresholds and approximately 15% in terms of the segmental edit distance score. The EffNetV2 C-ECT outperforms EffNetV2 Causal ASFormer by approximately 7% in terms of the segmental edit distance score and by approximately 4.5% in terms of the average segmental F1 score. The EffNetV2 C-ECT with CAFF outperforms EffNetV2 C-ECT by approximately 3% in terms of the segmental edit distance score and by approximately 6% in terms of the average segmental F1 score. These results demonstrate that the EffNetV2 C-ECT with CAFF outperforms other methods for the surgical phase recognition task on Cholec80.

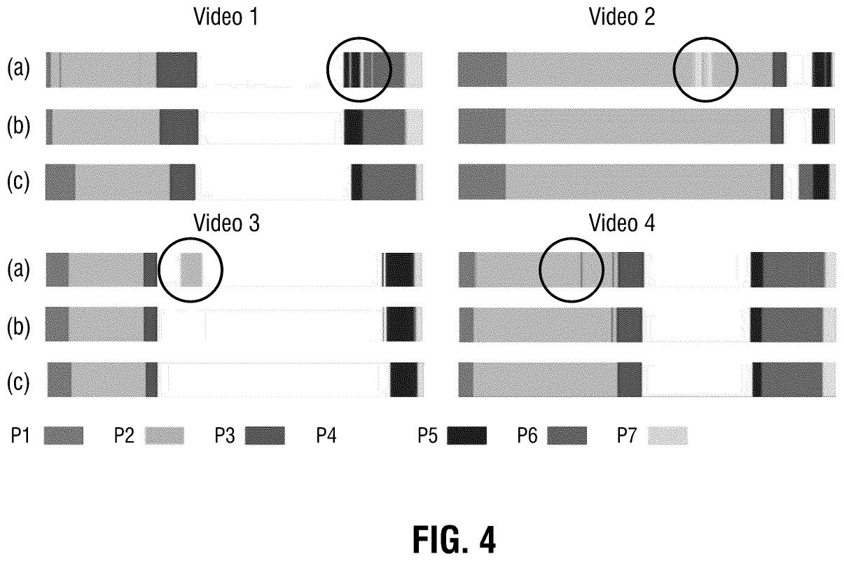

FIG. 4 is a color-coded ribbon illustration that visualizes the results of predicting seven, P1-P7, surgical phases in 4 different videos (of 4 different surgery sessions.) The results are for a) the EffNetV2 MS-TCN and b) EffNetV2 C-ECT with CAFF, while c) is the Ground Truth. Circled are some of the inaccurate predictions made by a) the EffNetV2 MS-TCN. These visualizations demonstrate that the predictions made by b) the EffNetV2 C-ECT with CAFF are closer to c) the Ground Truth at least because it produces fewer over-segmentation errors and out-of-order predictions as compared to a) the EffNetV2 MS-TCN.

As described above there, one aspect of the disclosure here is a modification of ASFormer into Causal ASFormer along with a modification of CETNet to Cross-Enhancement Causal Transformer (C-ECT) for online surgical phase recognition. Also, Cross-Attention Feature Fusion (CAFF) is used for a better fusion of the cross-attention features. With EffNetV2 as the feature extraction backbone, an aspect of the disclosure here is EffNetV2 MS-TCN, EffNetV2 C-ECT, and EffNetV2 C-ECT with CAFF for online surgical phase recognition. These methods outperform most if not all state of the art methods as of the priority date of this patent application. EffNetV2 C-ECT with CAFF outperforms other methods in both frame-level evaluation metrics and segmental metrics. It generates fewer over-segmentation errors and out-of-order predictions and it can produce consistent, smooth, and accurate predictions.

What is claimed is:

1. A system, comprising:
one or more processors and a memory storing instructions to be executed by the one or more processors to:
extract a sequence of extracted feature sets from a surgical video frame by frame;
analyze the sequence of extracted feature sets to recognize one or more surgical actions; and
segment the surgical video into a plurality of video segments, each video segment corresponding to a recognized surgical action.

2. The system of claim 1, wherein the processor extracts the sequence using a feature extraction network.

3. The system of claim 2, wherein the feature extraction network is a family of image classification neural networks.

4. The system of claim 1, wherein the processor analyzes and segments using an action segmentation network.

5. The system of claim 4, wherein the action segmentation network is based on a transformer model including one or more encoder blocks and one or more decoder blocks.

6. The system of claim 5, wherein each of the one or more encoder blocks includes a dilated causal convolution and a self-attention layer based on a causal local attention with residual connections.

7. The system of claim 6, wherein each of the one or more decoder blocks includes a dilated causal convolution and a cross-attention layer based on the causal local attention.

8. The system of claim 7, wherein an input to the cross-attention layer in a decoder block includes an output from the self-attention layer in a corresponding encoder block in the transformer model.

9. A method surgical phase recognition, comprising the following operations performed by a programmed processor:
extracting a sequence of extracted feature sets from a surgical video frame by frame;
analyzing the sequence of extracted feature sets to recognize one or more surgical actions; and
segmenting the surgical video into a plurality of video segments, each video segment corresponding to a recognized surgical action.

10. The method of claim 9, wherein extracting the sequence of extracted feature sets from the surgical video is performed by a feature extraction network.

11. The method of claim 10, wherein the feature extraction network is a family of image classification neural networks.

12. The method of claim 9, wherein analyzing the sequence of extracted feature sets and segmenting the surgical video is performed by an action segmentation network.

13. The method of claim 12, wherein the action segmentation network is based on a transformer model including one or more encoder blocks and one or more decoder blocks.

14. The method of claim 13, wherein each of the one or more encoder blocks includes a dilated causal convolution and a self-attention layer based on a causal local attention with residual connections.

15. The method of claim 14, wherein each of the one or more decoder blocks includes a dilated causal convolution and a cross-attention layer based on the causal local attention.

16. The method of claim 15, wherein an input to the cross-attention layer in a decoder block includes an output from the self-attention layer in a corresponding encoder block in the transformer model.

17. An article of manufacture comprising a machine readable medium having stored therein instructions that configure a computer to perform surgical action recognition by:
extracting a sequence of extracted feature sets from a surgical video frame by frame;
analyzing the sequence of extracted feature sets to recognize one or more surgical actions; and
segmenting the surgical video into a plurality of video segments, each video segment corresponding to a recognized surgical action.

18. The article of manufacture of claim 17 wherein the machine readable medium has stored therein instructions that configure the computer to extract the sequence of extracted feature sets from the surgical video by using a feature extraction network.

19. The article of manufacture of claim 18 wherein the feature extraction network is a family of image classification neural networks.

20. The article of manufacture of claim 19 wherein analyzing the sequence of extracted feature sets and segmenting the surgical video is performed by an action segmentation network that is based on a transformer model including, one or more encoder blocks and one or more decoder blocks, wherein each of the one or more encoder blocks includes a dilated causal convolution and a self-attention layer based on a causal local attention with residual connections.
